(19) United States
(12) Patent Application Publication
(10) Pub. No.: US 2022/0198126 A1
(43) Pub. Date: Jun. 23, 2022

(54) DISPLAY DEVICE AND DISPLAY CONTROL METHOD

(71) Applicant: KYOCERA Document Solutions Inc., Osaka (JP)

(72) Inventor: Tetsuya NISHINO, Osaka-shi (JP)

(73) Assignee: KYOCERA Document Solutions Inc., Osaka (JP)

(21) Appl. No.: 17/604,346

(22) PCT Filed: Mar. 6, 2020
(86) PCT No.: PCT/JP2020/009617

§ 371 Date: Oct. 15, 2021

(30) Foreign Application Priority Data
Apr. 17, 2019 (JP) 2019-078586

(51) Int. Cl. G06F 40/109; G06F 40/18

(52) U.S. Cl. CPC G06F 40/109; G06F 3/0482; G06F 40/18

(57) ABSTRACT

A display device (100) includes a receiving section (12), a registering section (2112), a display section (11), an identifying section (2111), and a changing section (212). The receiving section (12) receives selection of a label from a user. The registering section (2112) registers the label and a format set in association with each other. The format set includes format items to be embodied in a character display format and format contents each indicating a content of a corresponding one of the format items. The display section (11) displays a character string including a first character. The identifying section (211) identifies the first character. The changing section (212) changes the character display format of the first character based on the format set associated with the label.

### TECHNICAL FIELD

The present invention relates to a display device and a display control method.

### BACKGROUND ART

In order to increase work efficiency, various improvements are made in application software in which a format is settable, such as spreadsheet software and document creation software. For example, in order to streamline format change of a plurality of areas, a technique (e.g., Patent Literature 1) is proposed in which when format change is performed on in a certain area, the same format change is performed on the other areas.

### CITATION LIST

### Patent Literature

[Patent Literature 1] Japanese Patent Application Laid-Open Publication No. H8-30587

### SUMMARY OF INVENTION

### Technical Problem

However, the technique disclosed in Patent Literature 1 is complicated because of necessity of additional operation for creating a list of areas of which format is to be changed to the same format. Therefore, there is room for improvement.

The present invention has been made in view of the foregoing problem and has its object of providing a display device and a display control method that enable easy format change in application software in which a format is settable.

### Solution to Problem

A display device according to the present invention includes a receiving section, a registering section, a display section, an identifying section, and a changing section. The receiving section receives selection of a label from a user. The registering section registers the label and a format set in association with each other. The format set includes format items to be embodied in a character display format and format contents each indicating a content of a corresponding one of the format items. The display section displays a character string including a first character. The identifying section identifies the first character. The changing section changes the character display format of the first character based on the format set associated with the label.

A display control method according to the present invention includes: receiving selection of a label from a user; registering the label and a format set in association with each other, the format set including format items to be embodied in a character display format and format contents each indicating a content of a corresponding one of the format items; displaying a character string including a first character; identifying the first character; and changing the character display format of the first character based on the format set associated with the label.

### Advantageous Effects of Invention

According to the present invention, format change can be facilitated in application software in which a format is settable.

### BRIEF DESCRIPTION OF DRAWINGS

FIG. 1 is a block diagram of the configuration of a display device according to an embodiment of the present invention.

FIG. 2 illustrates a display example of a pulldown list in the embodiment.

FIG. 3 is a diagram illustrating an example of a format setting screen in the embodiment.

FIG. 4 is a diagram illustrating an example of another format setting screen in the embodiment.

FIG. 5 is a diagram illustrating an example of a format setting table in the embodiment.

FIG. 6 is a flowchart depicting a former half of a format setting process according to the embodiment.

FIG. 7 is a flowchart depicting a latter half of the format setting process according to the embodiment.

### DESCRIPTION OF EMBODIMENTS

The following describes an embodiment of the present invention with reference to the accompanying drawings. Note that elements that are the same or equivalent are indicated by the same reference signs in the drawings and description thereof is not repeated.

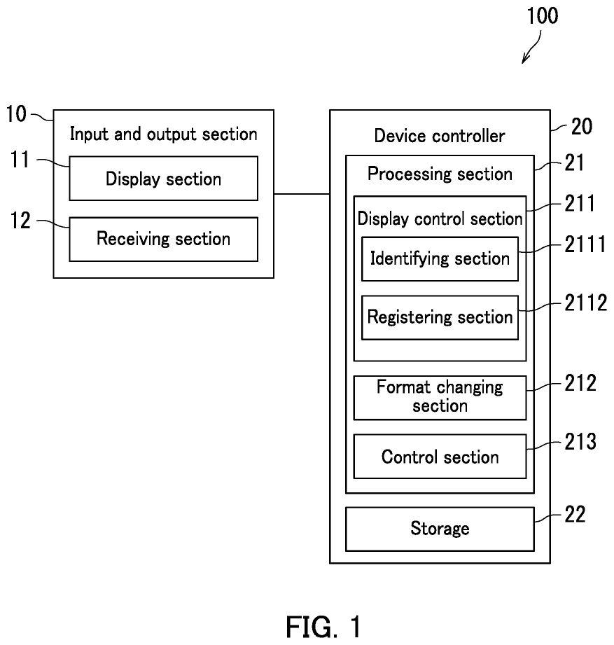

With reference to FIG. 1, a display device 100 according to an embodiment of the present invention will be described first. The display device 100 sets a label representing a combination of a plurality of format items according to a user instruction. The label is associated with a format set of the format items. When the user sets or selects a label, a plurality of format items can be set or changed at once. In the present embodiment, the display device 100 is a personal computer capable of activating application software such as spreadsheet software and document creation software.

The following describes in detail a format set and the label in the present embodiment. In the present embodiment, the format set includes format items and format contents. The format items each are a type of format. For example, the format items include a type of format “font name”. The format contents each are a specific content of a corresponding one of the format items. The format content of the format item “font name” includes a selection candidate “P Gothic”, for example. The label represents a format set as a combination of the format items. The user is allowed to set any character string as the label. That is, the display device 100 receives a character string such as “Standard” or “Latest update information” as a label name of the label from the user.

FIG. 1 is a block diagram of the configuration of the display device 100 according to the present embodiment. The display device 100 includes an input and output section 10 and a device controller 20.

The input and output section 10 informs the user of various information. Furthermore, the input and output section 10 receives various instructions from the user. The input and output section 10 includes a display section 11 and a receiving section 12.

The display section 11 displays various information on a screen thereof. Specifically, the input and output section 10 displays information relating to format setting or format change on the screen. In the present embodiment, the display section 11 displays at least the format items. The display section 11 includes a display and a touch sensor. The display section 11 is a touch panel including a liquid-crystal display, for example.

The receiving section 12 includes a numeric keypad and a character input key set, for example. The receiving section 12 receives various instructions from the user through the numeric keypad or the character input key set. Specifically, the receiving section 12 receives an instruction relating to format setting or format change from the user. In the present embodiment, the receiving section 12 receives at least selection of a label from the user. No particular limitations are placed on the language defining the label. The user may defme the label in Japanese or a foreign language such as English or defme the label with a sign including a number or a character. Furthermore, the receiving section 12 receives the label and format contents corresponding to the respective format items from the user.

As illustrated in FIG. 1, the device controller 20 includes a processing section 21 and storage 22. The processing section 21 is a processor, for example. The processor is a central processing unit (CPU), for example. The processing section 21 executes a control program stored in the storage 22 to control operation of each element of the display device 100.

The storage 22 stores various data and the control program therein. The storage 22 includes read-only memory (ROM), random-access memory (RAM), and/or a solid state drive (SSD), for example. The storage 22 may include external memory. The external memory is a removable medium. The storage 22 may include for example universal serial bus (USB) memory and/or a secure digital (SD) card as external memory.

The processing section 21 includes a display control section 211, a format changing section 212, and a control section 213. The display control section 211 includes an identifying section 2111 and a registering section 2112. In the present embodiment, as a result of the processing section 21 executing the control program stored in the storage 22, the control program implements functions of the display control section 211, the format changing section 212, the control section 213, the identifying section 2111, and the registering section 2112.

The display section 11 displays a character string. The identifying section 2111 identifies at least one character included in the displayed character string according to a user instruction. Specifically, the identifying section 2111 identifies a character or characters composing a part of the character string located within a cell that is an area surrounded by a line, and excludes the other character(s). In the present embodiment, the identifying section 2111 identifies a character or characters composing a part of the character string located within the cell in spreadsheet software. Alternatively, the identifying section 2111 may identify at least one character in document creation software.

The registering section 2112 registers a label and a format set of the format items in association with each other in the storage 22. Specifically, based on an instruction received from the user through the receiving section 12, the registering section 2112 registers in the storage 22 a format setting table in which a label and a format set of the format items are defined in association with each other.

The format changing section 212 changes a character display format of the identified character(s) based on the format set of the format items corresponding to the label received through the receiving section 12. Furthermore, the format changing section 212 updates the format setting table.

In the present embodiment, the format changing section 212 changes the format contents of application software in which a format is settable based on the format contents of the format set associated with a label selected by the user. The format changing section 212 is an example of a “changing section”. In the following, application software in which a format is settable may also referred to simply as “application software”.

Furthermore, the format changing section 212 applies the changed format contents to the character(s) identified by the identifying section 2111 or applies the changed format contents to a character input after change of the format content.

Specifically, the format changing section 212 may determine when to apply the changed format contents to a character or a character string input through the receiving section 12. For example, when format change is performed by the format changing section 212 after an input character or character string is identified for example by “highlighting”, the changed format contents are applied only to the identified character or character string. By contrast, when format change is performed by the format changing section 212 in a situation in which neither a character nor a character string is identified, the changed format contents may be applied to a character or character string input after format change is performed. Alternatively, the format changing section 212 may apply the changed format contents only to the identified character or character string located in a cell, and may apply the changed format contents to a character or character string input in the cell after format change.

The control section 213 activates application software in which a format is settable unit by unit of the format set including the format items to be embodied in a character display format and the format contents indicating the contents of the corresponding format items.

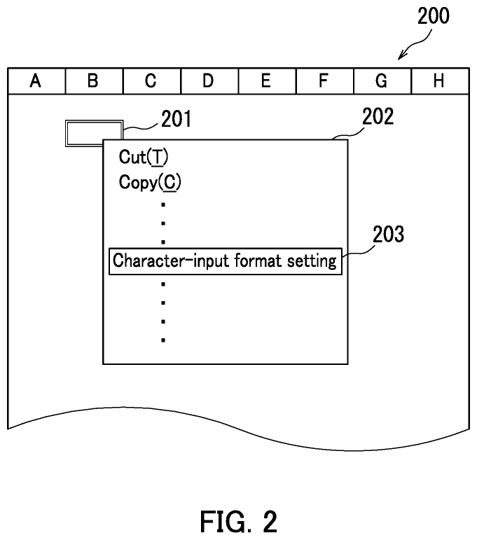

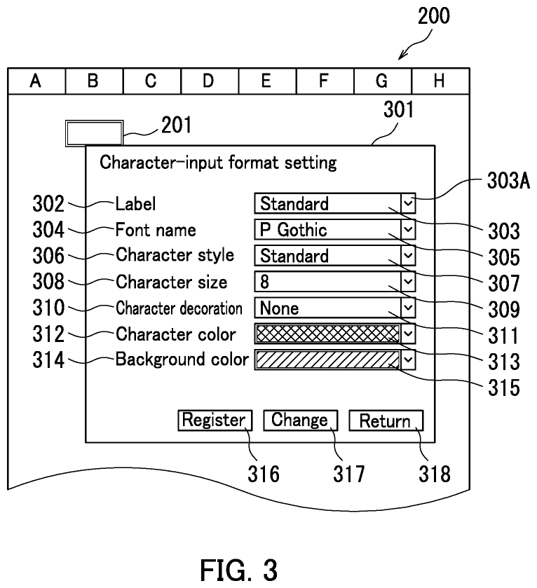

With reference to FIGS. 2 and 3, a format setting method according to the present embodiment will be described next. FIG. 2 illustrates a display example of a spreadsheet screen 200 in the present embodiment. Specifically, the spreadsheet screen 200 in FIG. 2 displays a spreadsheet for example when spreadsheet software being application software is activated. As illustrated in FIG. 2, the spreadsheet screen 200 includes a cell 201 and a pulldown list 202.

In the present embodiment, when the control section 213 activates the spreadsheet software, the spreadsheet screen 200 is displayed. Upon receiving selection of the cell 201 from the user through the receiving section 12, the display control section 211 causes display of the pulldown list 202. Upon receiving for example “right click” on the cell 201 by the user through the receiving section 12, the display control section 211 causes display of the pulldown list 202. In the present embodiment, the pulldown list 202 includes a character-input format setting list 203. Upon receiving selection of the character-input format setting list 203 from the user through the receiving section 12, the display control section 211 causes display of a format setting sub-screen 301 (see FIG. 3).

FIG. 3 illustrates a display example of the format setting sub-screen 301 in the present embodiment. As illustrated in FIG. 3, the user is allowed to set a format content for each of the format items in association with a label 302 through the format setting sub-screen 301. In the present embodiment, the format items include a font name 304, a character style 306, a character size 308, a character decoration 310, a character color 312, and a background color 314. Furthermore, the format setting sub-screen 301 includes a registration button 316, a change button 317, and a return button 318.

In the present embodiment, a selection candidate “Standard” 303 is being set as a label name for the label 302. For the font name 304, a selection candidate “P Gothic” 305 is being set as a format content. For the character style 306, a selection candidate “Standard” 307 is being set as a format content. For the character size 308, a selection candidate “8” 309 is being set as a format content. For the character decoration 310, a selection candidate “None” 311 is being set as a format content. For the character color 312, a selection candidate “Black” (cross hatching) 313 is being set as a format content. For the background color 314, a selection candidate “Yellow” (hatching in an upward and rightward direction) 315 is being set as a format content.

The user is allowed to set the label name 303 and the selection candidates “P Gothic” 305 to “Yellow (hatching in an upward and rightward direction)” 315 each corresponding to one of the format items of the font name 304 to the background color 314 while watching the format setting sub-screen 301. A dropdown button 303A is a button to be operated to display a list of selection candidates for the label name 303. Upon the user operating the dropdown button 303A, “Standard”, “Latest update information”, “Today's task”, and “NULL label” are displayed as selection candidates for the label name 303, for example. The “NULL label” is a label to which no character strings are set. As illustrated in FIG. 3, a button similar to the dropdown button 303A may be provided for each of the format contents indicated as the selection candidate P Gothic 305 to the selection candidate “Yellow (hatching in an upward and rightward direction)” 315.

The registration button 316 is a button to be pressed for registration of format contents in association with a label. The change button 317 is a button to be pressed for at once change of the format contents associated with the label. The return button 318 is a button to be pressed for return to the previous screen.

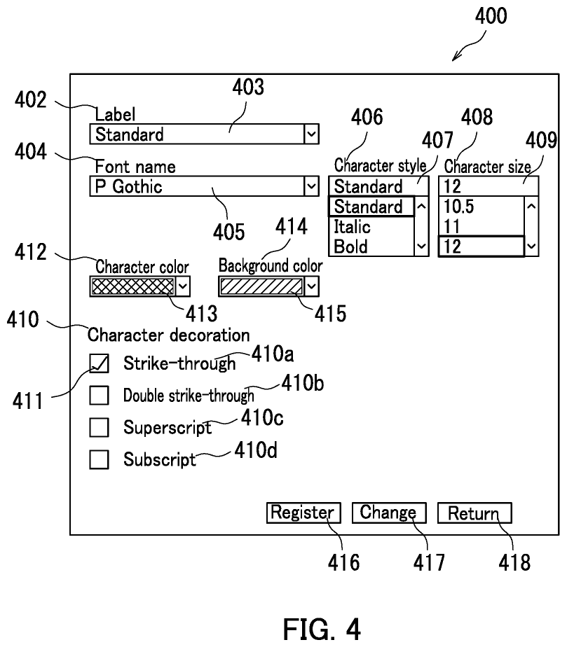

With reference to FIG. 4, a format setting method in a case in which document creation software is activated rather than the spreadsheet software will be described next. FIG. 4 is a diagram illustrating an example of a format setting sub-screen 400 of the document creation software. As illustrated in FIG. 4, the user is allowed to set the format contents corresponding to the respective format items in association with a label 402 through the format setting sub-screen 400. The format items include a “font name” 404, a “character style” 406, a “character size” 408, a “character decoration” 410, a “character color” 412, and a “background color” 414 likewise the format setting sub-screen 301 described with reference to FIG. 3. Furthermore, the format setting sub-screen 400 includes a registration button 416, a change button 417, and a return button 418.

In the present embodiment, a selection candidate “Standard” 403 is being set as a label name for the label 402. For the font name 404, a selection candidate “P Gothic” 405 is being set as a format content. For the character style 406, a selection candidate “Standard” 407 is being set as a format content. For the character size 408, a selection candidate “12” 409 is being set as a format content. For the character decoration 410, a check box” 411 for a selection candidate “Strike-through” 410a is being checked as a format content. As to the character decoration 410, any other check boxes for a selection candidate “Double strike-through” 410b, a selection candidate “Superscript” 410c, and a selection candidate “Subscript” 410d may be checked as other or additional to-be-set format contents. For the character color 412, a selection candidate “Black” (cross hatching)” 413 is being set as a format content. For the background color 414, a selection candidate “Yellow (hatching in an upward and rightward direction)” 415 is being set as a format content.

The registration button 416 is a button to be pressed for registration of format contents for the format items in association with a label. The change button 417 is a button to be pressed for at once change of the format contents associated with a label. The return button 418 is a button to be pressed for return to the previous screen.

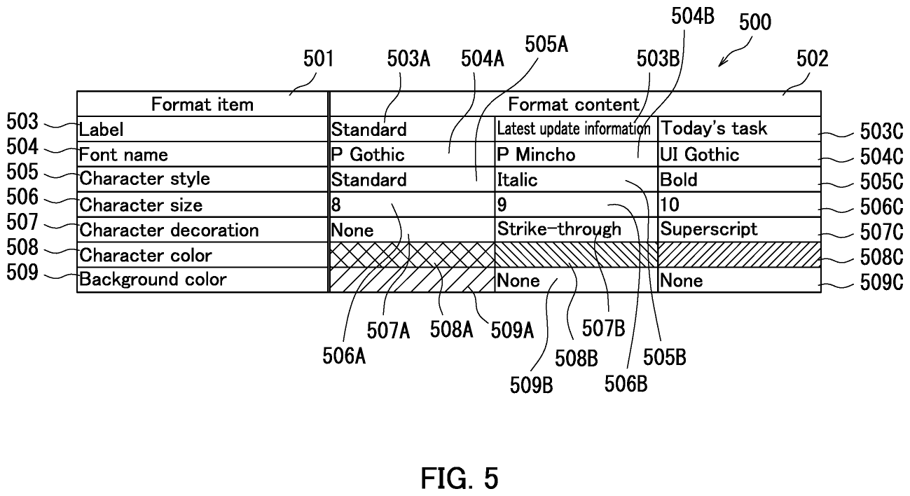

FIG. 5 is a diagram illustrating an example of a format setting table 500 in the present embodiment. The format setting table 500 is registered in the storage 22 by the display control section 211.

As illustrated in FIG. 5, the format setting table 500 includes a format item column 501 and a format content column 502. In the format setting table 500, data indicated in the format item column 501 corresponds to the label 302 and the format items, and data indicated in the format content column 502 corresponds to selection candidates for the label name 303 and selection candidates for the format contents corresponding to the respective format items described with reference to FIG. 3. The format items in FIG. 3 include the font name 304 to the background color 314. The selection candidates for the format contents in FIG. 3 include the selection candidate “P Gothic” 305 to the selection candidate “Yellow (hatching in an upward and rightward direction)” 315.

In the present embodiment, the format item column 501 indicates a label 503, a font name 504, a character style 505, a character size 506, a character decoration 507, a character color 508, and a background color 509.

Furthermore, in the present embodiment, the format content column 502 indicates a selection candidate “Standard” 503A that is a label name for the label 503, and a selection candidate “P Gothic” 504A, a selection candidate “Standard” 505A, a selection candidate “8” 506A, a selection candidate “None” 507A, a selection candidate “Black (cross hatching)” 508A, and a selection candidate “Yellow (hatching in an upward and rightward direction)” 509A that are selection candidates for the format contents each corresponding to one of the format items of the font name 504 to the background color 509. Similarly, the format content column 502 indicates a selection candidate “Latest update information” 503B that is a label name for the label 503, and a selection candidate “P Mincho” 504B, a selection candidate “Italic” 505B, a selection candidate “9” 506B, a selection candidate “Strike-through” 507B, a selection candidate “Red (thick hatching in a downward and rightward direction)” 508B, and a selection candidate “None” 509B that are the format contents each corresponding to one of the format items of the font name 504 to the background color 509. Furthermore, the format content column 502 indicates a selection candidate “Today's task” 503C that is a label name for the label 503, and a selection candidate “UI Gothic” 504C, a selection candidate “Bold” 505C, a selection candidate “10” 506C, a selection candidate “Superscript” 507C, a selection candidate “Green (thick hatching in an upward and rightward direction)” 508C, and a selection candidate “None” 509C that are the format contents each corresponding to one of the format items of the font name 504 to the background color 509.

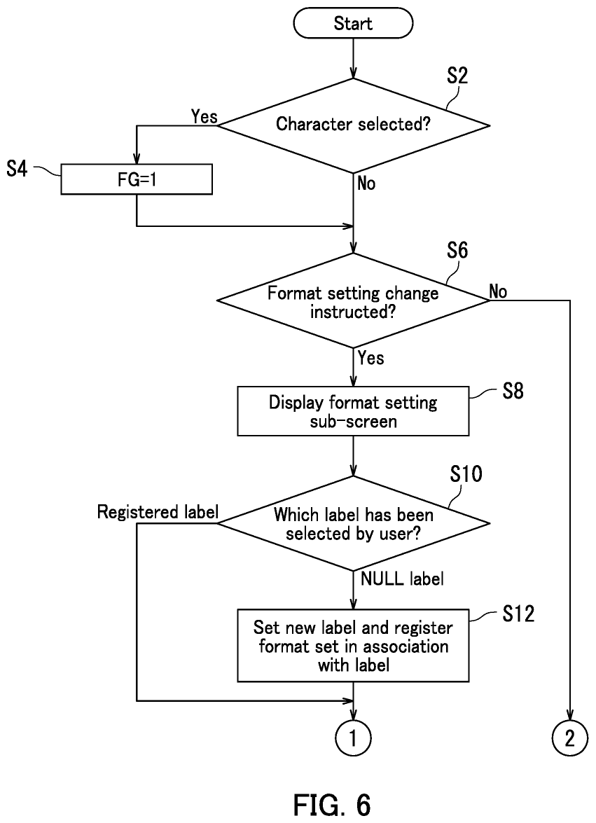

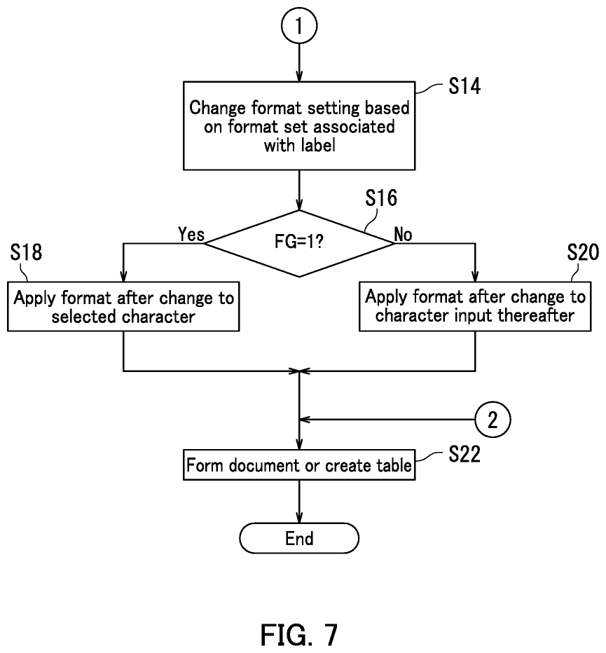

With reference to FIGS. 1 to 7, a format setting process according to the present embodiment will be described next. FIG. 6 is a flowchart depicting a former half of an example of the format setting process. FIG. 7 is a flowchart depicting a latter half of the example of the format setting process. Here, the term “format setting process” refers to a process to set the format of a character. The format setting process includes processing for format change. The format setting process is executed through Steps S2 to S22. Note that, the value of a character selection flag FG is set to “0” in default settings. The character selection flag FG is a flag indicating whether or not a character has been selected by a user.

Step S2: Upon the spreadsheet software or the document creation software being activated, the display control section 211 determines whether or not a character has been selected. If the display control section 211 determines that a character has been selected (Yes in Step S2), the routine proceeds to Step S4. If the display control section 211 determines that no character has been selected (No in Step S2), the routine proceeds to Step S6.

Step S4: The display control section 211 sets the value of the character selection flag FG to “1”. The routine proceeds to Step S6.

Step S6: The display control section 211 determines whether or not there are any user instructions for format setting change. For example, the display control section 211 determines whether or not the character-input format setting list 203 has been selected by the user. If the display control section 211 determines that there is a user instruction for format setting change (Yes in Step S6), the routine proceeds to Step S8. If the display control section 211 determines that there are no user instructions for format setting change (No in Step S6), the routine proceeds to Step S22 in FIG. 7.

Step S8: The display control section 211 causes display of the format setting sub-screen 301 or the format setting sub-screen 400. The routine proceeds to Step S10.

Step S10: The display control section 211 determines which label has been selected by the user. If the display control section 211 determines that the label selected by the user is a “registered label” that has been already registered (“Registered label” in Step S10), the routine proceeds to Step S14 in FIG. 7. If the display control section 211 determines that the label selected by the user is a “NULL label” that has not yet been registered (“NULL label” in Step S10), the routine proceeds to Step S12.

Step S12: The format changing section 212 sets a new label based on a user instruction and registers a format set of the format items in association with the new label. The routine proceeds to Step S14 in FIG. 7.

Step S14: The format changing section 212 changes the format setting based on the format set of the format items associated with the label. The routine proceeds to Step S16.

Step S16: The display control section 211 determines whether or not the value of the character selection flag FG is “1”. If the display control section 211 determines that the value of the character selection flag FG is “1” (Yes in Step S16), the routine proceeds to Step S18. If the display control section 211 determines that the value of the character selection flag FG is not “1” (No in Step S16), the routine proceeds to Step S20.

Step S18: The display control section 211 applies the format after the format setting change to the selected character. The routine proceeds to Step S22.

Step S20: The display control section 211 applies the format after the format setting change to a character input after the format setting change. The routine proceeds to Step S22.

Step S22: The display control section 211 continues document formation or table creation. The routine ends then.

As has been described so far with reference to FIGS. 1 to 7, the display device 100 allows the user to set a label in association with a format set that is a combination of a plurality of format items for format setting of activated application software. In the above configuration, when the user selects a label, the format items can be set or changed at once on a character by character basis. In the above configuration, the user using the display device 100 can easily perform format change in application software in which a format is settable.

An embodiment of the present invention has been described so far with reference to the accompanying drawings. However, the present invention is not limited to the above-described embodiment and can be practiced in various ways within the scope not departing from the essence of the present invention (e.g., (1) to (3) described below). Furthermore, any elements of configuration disclosed in the above embodiment can be combined as appropriate for formation of various inventions. For example, some elements of configuration may be omitted from all the elements of configuration indicated in the embodiment. Moreover, elements of configuration in different embodiments may be combined as appropriate. The drawings schematically illustrate elements of configuration in order to facilitate understanding, and properties of elements of configuration illustrated in the drawings, such as length, interval, and number thereof, may differ from actual properties thereof in order to facilitate preparation of the drawings. In addition, the shape, dimension, and the like of each element of configuration indicated in the above embodiment are examples and are not intended as specific limitations. Various alterations can be made within the scope not substantially departing from the effects of the present invention.

(1) The display device 100 of the present invention is not limited to a personal computer. For example, the display device 100 may be a mobile device such as a smartphone or a tablet terminal.

(2) Furthermore, the display device 100 of the present invention may be an image forming apparatus such as a multifunction peripheral capable of activating application software such as spreadsheet software or document creation software.

(3) In addition, the present invention can be implemented as a display control method including steps implemented by characteristic elements of configuration in the display device 100 of the present invention or implemented as a display control program including the steps. Moreover, the program may be distributed through a storage medium that non-transitorily stores the program therein, such as compact disk (CD)-ROM, or a transmission medium such as a communication network.

### INDUSTRIAL APPLICABILITY

The present invention relates to the display device 100 and has industrial applicability.

1. A display device comprising:
a receiving section configured to receive selection of a label from a user;
a registering section configured to register the label and a format set in association with each other, the format set including format items to be embodied in a character display format and format contents each indicating a content of a corresponding one of the format items;
a display section configured to display a character string including a first character;
an identifying section configured to identify the first character; and
a changing section configured to change the character display format of the first character based on the format set associated with the label.

2. The display device according to claim 1, wherein
the first character is a character located within a cell that is an area surrounded by a line, and
the identifying section excludes any characters located in the cell other than the first character.

3. A display control method comprising:
receiving selection of a label from a user;
registering the label and a format set in association with each other, the format set including format items to be embodied in a character display format and format contents each indicating a content of a corresponding one of the format items;
displaying a character string including a first character;
identifying the first character; and
changing the character display format of the first character based on the format set associated with the label.
